(19) United States
(12) Patent Application Publication
(10) Pub. No.: US 2024/0212189 A1
(43) Pub. Date: Jun. 27, 2024

(54) 3D PERCEPTION

(71) Applicant: FIVE AI LIMITED, Cambridge (GB)

(72) Inventors: Tommaso Cavallari, Oxford (GB); Mihaela-Cãtãlina Stoian, Cambridge (GB); John Redford, Cambridge (GB)

(73) Assignee: FIVE AI LIMITED, Cambridge (GB)

(21) Appl. No.: 18/287,370

(22) PCT Filed: Apr. 20, 2022
(86) PCT No.: PCT/EP2022/060438

§ 371 Date: Oct. 18, 2023

(30) Foreign Application Priority Data
Apr. 20, 2021 (GB) 2105637.9

(51) Int. Cl. G06T 7/68; G06T 7/73; G06T 15/10; G06V 10/44; G06V 10/82

(52) U.S. Cl. CPC G06T 7/68; G06T 7/73; G06T 15/10; G06V 10/44; G06V 10/82; G06T 2207/30248; G06T 2210/12

(57) ABSTRACT

A computer-implemented method of estimating a 3D object pose, the method comprising: receiving 3D data comprising a full or partial view of a 3D object, the 3D object exhibiting reflective symmetry about an unknown 2D symmetry plane; applying symmetry detection to the 3D data, and thereby calculating, in 3D space, an estimated 2D symmetry plane for the 3D object; and applying 3D pose detection to the 3D data based on the estimated 2D symmetry plane, thereby computing a 3D pose estimate of the 3D object that is informed by the reflective symmetry of the 3D object.

### TECHNICAL FIELD

The present disclosure pertains generally to machine learning (ML)-based perception, and in particular to ML perception of 3D structure (3D perception). 3D structure may be captured in 3D data such as stereo image data, depth data/depth images, lidar, radar, time-of-flight etc.

### BACKGROUND

In a machine learning (ML) context, a structure perception component may comprise one or more trained perception models. For example, machine vision processing is frequently implemented using convolutional neural networks (CNNs). Such networks are typically trained on large numbers of training images which have been annotated with information that the neural network is required to learn (a form of supervised learning). At training time, the network is presented with thousands, or preferably hundreds of thousands, of such annotated images and learns for itself how features captured in the images themselves relate to annotations associated therewith. This is a form of visual structure detection applied to images. Each image is annotated in the sense of being associated with annotation data. The image serves as a perception input, and the associated annotation data provides a “ground truth” for the image.

CNNs and other forms of perception model can be architected to receive and process other forms of perception inputs, such as point clouds, voxel tensors etc., and to perceive structure in both 2D and 3D space. In the context of training generally, a perception input may be referred to as a “training example” or “training input”. By contrast, perception inputs captured for processing by a trained perception component at runtime may be referred to as “runtime inputs”. Annotation data associated with a training input provides a ground truth for that training input in that the annotation data encodes an intended perception output for that training input. In a supervised training process, parameters of a perception component are tuned systematically to minimize, to a defined extent, an overall measure of difference between the perception outputs generated by the perception component when applied to the training examples in a training set (the “actual” perception outputs) and the corresponding ground truths provided by the associated annotation data (the intended perception outputs). In this manner, the perception input “learns” from the training examples, and moreover is able to “generalize” that learning, in the sense of being able, once trained, to provide meaningful perception outputs for perception inputs it has not encountered during training.

Such perception components are a cornerstone of many established and emerging technologies. For example, in the field of robotics, mobile robotic systems that can autonomously plan their paths in complex environments are becoming increasingly prevalent. An example of such a rapidly emerging technology is autonomous vehicles (AVs) that can navigate by themselves on urban roads. Such vehicles must not only perform complex manoeuvres among people and other vehicles, but they must often do so while guaranteeing stringent constraints on the probability of adverse events occurring, such as collision with these other agents in the environments. In order for an AV to plan safely, it is crucial that it is able to observe its environment accurately and reliably. This includes the need for accurate and reliable detection of real-world structure in the vicinity of the vehicle. An autonomous vehicle, also known as a self-driving vehicle, refers to a vehicle which has a sensor system for monitoring its external environment and a control system that is capable of making and implementing driving decisions automatically using those sensors. This includes in particular the ability to automatically adapt the vehicle's speed and direction of travel based on perception inputs from the sensor system. A fully-autonomous or “driverless” vehicle has sufficient decision-making capability to operate without any input from a human driver. However, the term autonomous vehicle as used herein also applies to semi-autonomous vehicles, which have more limited autonomous decision-making capability and therefore still require a degree of oversight from a human driver. Other mobile robots are being developed, for example for carrying freight supplies in internal and external industrial zones. Such mobile robots would have no people on board and belong to a class of mobile robot termed UAV (unmanned autonomous vehicle). Autonomous air mobile robots (drones) are also being developed.

### SUMMARY

Various inventive aspects are disclosed herein. Certain aspects pertain to novel forms and/or applications of symmetry detection. Another aspect pertains to a novel form of encoder architecture, that can be applied to symmetry detection, but also other 3D perception tasks such as shape completion.

A first aspect herein relates to 3D object pose estimation, exploiting known or assumed object characteristics—specifically, reflective symmetry—to improve the accuracy of the 3D pose detection. An object is said to exhibit reflective symmetry if there exists at least one 2D plane (symmetry plane) such that a reflection of the 3D object across the plane would result in approximately the same object. Many real-world objects exhibit such symmetry. The present techniques do not require exact symmetry, and can work with any kind of 3D object that is approximately symmetrical.

A computer-implemented method of estimating a 3D object pose, in accordance with the first aspect, comprises:
receiving 3D data comprising a full or partial view of a 3D object, the 3D object exhibiting reflective symmetry about an unknown 2D symmetry plane;
applying symmetry detection to the 3D data, and thereby calculating an estimate, in 3D space, of the 2D symmetry plane of the object; and
applying 3D pose detection to the 3D data based on the estimate of the 2D symmetry plane, thereby computing a 3D pose estimate of the 3D object that is informed by the reflective symmetry of the 3D object.

In embodiments, an initial 3D pose estimate may be computed, and a refined 3D pose estimate may be computed based on the initial 3D pose estimate and the 2D symmetry plane.

The initial 3D pose estimate may be used to “crop” the 3D data, in order to isolate the view of the 3D object for the purpose of symmetry detection. That is, the initial 3D pose estimate may be used to extract a subset of object data from the 3D data, and the symmetry detection may be applied to the extracted subset of object data. For example, the subset of object data may be extracted based on the initial 3D pose estimate and an estimated extent of the 3D object. For example, the initial 3D pose estimate and the estimated extent may be provided in the form of a detected 3D bounding box or other 3D bounding object for the 3D object (e.g. as determined using a conventional 3D bounding box detector applied to the 3D data).

The refined 3D pose estimate may, for example, be computed by transforming the initial 3D pose estimate based on at least one assumption about a location and/or orientation of the 3D object relative to the symmetry plane. For example, in order to compute the refined 3D pose estimate, the aforementioned 3D bounding object may be transformed (e.g. rotated and/or translated in 3D space) so that that the transformed 3D bounding object has a predetermined geometric relationship to the symmetry plane (e.g. such that the symmetry plane lies along a predefined axis of 3D bounding object).

As another example, the symmetry detection could be used to inform the pose detection by running the symmetry detection method on top of every proposal bounding box generated by a two stage detector (for example Faster-RCNN), and using the estimated plane when scoring and choosing the boxes to output.

3D pose means the pose (location and/or orientation) of the object in 3D space. The pose detection may, for example, operate over six degrees of freedom (6DOF) in 3D space, to estimate both location and orientation of the object in 3D space (e.g. encoded in six dimensions of a pose vector).

An example application of the present techniques is vehicle pose detection. A vehicle typically exhibits a single symmetry plane running along the length of the vehicle. Vehicle pose detection has many practical applications, including autonomous driving where the present techniques may be implemented within a perception system of an autonomous vehicle applied to on-board sensor data (e.g. lidar or stereo image data). Other examples include robotic perception more generally, and “offline” processing of 3D data e.g. to provide annotated data for the purpose of training, testing or scenario extraction and the like.

A second aspect of the present disclosure relates to a novel encoder architecture for extracting high-quality features from 3D structure.

Previous advances in 2D image processing have been driven by deep convolutional neural networks (CNNs). In computer vision (CV), the ability of CNNs to extract high quality features from images is well-established. Such features form the basis of many modern image processing tasks, such as 2D object detection, 2D bounding box detection, 2D object recognition etc. In this context, a 2D image is typically represented as a 2D tensor having a single channel or a 3D tensor having multiple channels. Consistent with the terminology used in the art, the terms “encoder” and “feature extractor” are used interchangeably herein.

In the context of CNNs, data is represented as tensors—a tensor being an array generalized to any number of dimensions. For example, a digital image with n channels can be described as a tensor of size n×x×y where x×y denotes the pixel dimensions of the image and n (height) is the number of image channels. With a single channel n=1 (as for a grayscale or monochromatic image), the tensor is said to be two-dimensional (2D); with multiple channels n>1, the tensor is said to be three-dimensional (3D). As is well known in the art, a convolution is applied to a tensor by “sliding” a filter along one or more dimensions of the tensor. The filter is defined by an array of filter weights of size h×d×w. A “2D convolution” applied to an input tensor of size H×D×W refers to the case of h=H, which is to say the height h of the filter matches the height H of the input tensor. In this case, the convolution aggregates across the full height of the tensor and slides along only two dimensions of the 3D tensor (depth D and width W, but not height H). The filter acts as a feature detector and the convolution of the filter with the input tensor results in a feature map of size 1× D′×W′. Typically, multiple filters are applied at each convolutional layer of a CNN, in order to compute a 3D output tensor formed by “stacking” the feature maps from the different filters (each channel of the 3D output tensor is the feature map of a single filter, and the height of the output tensor is equal to the number of filters applied at that layer). In traditional computer vision (CV) applications, CNNs are typically based on 2D convolutions of this nature, combined with other operations(s) such as pooling and non-linear transformations. Within a deep CNN, a very large number of filters may be applied, to compute e.g. hundreds or thousands of individual feature maps. 2D convolutions can be computed reasonably efficiently, making this task tractable on modern computer hardware.

CV methods can, in principle, be extended directly to 3D data based on 3D convolutions and 4D tensors. However, 3D convolutions are computationally expensive and, in practice, this approach typically requires some form of compromise, e.g. restricting the resolution of the tensors, in order to make the computations tractable.

The present encoder architecture allows high-quality local features to be extracted from 3D data in a computationally efficient manner, without relying on computationally expensive 3D convolutions. Symmetry detection is one example application of the novel encoder architecture, as in the embodiments described in detail below.

However, the encoder architecture has other applications, to extract high-quality features for other useful perception tasks such as 3D shape completion, 3D object recognition, 3D object detection etc. or any other desired 3D perception tasks or tasks.

A computer-implemented method of extracting features from 3D structure within a 3D volume of space, in accordance with the second aspect, comprises:
receiving a voxel representation of the 3D structure within the 3D volume, the voxel representation divided into horizontal slices; and
processing each slice in a 2D convolutional neural network (CNN), in order to extract a first feature tensor, based on 2D convolutions within the 2D CNN, each 2D convolution performed by sliding a filter across a horizontal plane in only two dimensions, the first feature tensor comprising one or more first feature maps encoding local features of any portion of the 3D structure occupying that slice.

In embodiments, the method may comprise generating a second feature tensor for each slice, by providing the first feature tensors as a sequenced input to a convolutional recurrent neural network (CRNN), with the sequenced input of first feature tensors ordered to match a vertical order of the slices.

Each first feature tensor of the sequenced input may be concatenated with a global feature tensor extracted from the 3D volume for processing in the CRNN. For example, the global feature tensor may be computed based on 2D convolutions applied to the 3D volume as a whole (effectively aggregating across the full height of the 3D volume).

In the present context, the 2D convolutional neural network that processes an individual slice may be referred to as a “slice encoder”. The global feature tensor may be computed by a “global” encoder that observes the whole volume. The global encoder may also take the form of a 2D CNN applied to the voxelized representation of the 3D structure as a whole.

Each first feature tensor may be concatenated with the same global features. So, at time t1, the CRNN may receive the features for slice 1 concatenated with the global features; at time t2, the CRNN may receive the features for slice 2, concatenated with the same global features etc. As the CRNN is a convolutional recurrent network, in each slice there are H×W “pixels”, and each “pixel” receives its per-slice features (different at each timestep), concatenated to its global features (which may be computed only once ahead of time).

It is important to note that the terms “horizontal” and “vertical” herein are arbitrary labels adopted for conciseness. A horizontal slice simply means a slice lying parallel to some arbitrarily chosen plane that is referred to as the horizontal plane for convenience; vertical simply means a direction perpendicular to that plane, and height simply refers to extent in that direction.

Each slice may be encoded as a voxel array that encodes the portion of the 3D structure occupying the slice (if any—it is possible that the 3D structure will only lie within a subset of the slices).

Each slice has a height hₛ (the height of the voxel array or, equivalently, the number of channels), which means the extent of the slice in the vertical direction (its vertical “thickness” as measured in voxels). To extract the first feature tensor, each slice is processed as an input tensor, with the voxel array defining hₛ channels of the input tensor.

Each slice may have a height hₛ greater than one voxel. A height hₛ greater than one provides a “context window” around a given channel of the slice for the purpose of feature extraction.

The above global feature tensor may be processed as an input tensor (having a greater number of channels) based on 2D convolutions, in essentially the same manner as each slice is processed individually.

Each voxel may be scalar-valued.

For example, the scalar value of each voxel may contain a scalar occupancy value that indicates whether the voxel is occupied by the 3D structure (as in the examples described below). However, other values could be used to represent the 3D structure; for example, if the 3D structure takes the form of a point cloud, each voxel could contain the number of points in the 3D structure falling within the bounds of the voxel itself.

The voxel values do not necessarily have to be scalars. For example, the voxel values could be 1D arrays, which are stacked and, hence, processed as extra channels by the 2D convolutions. For example, a 1D array could be used to encode multiple colour channels for the 3D structure that are stacked in this manner.

The slices may be vertically overlapping or non-overlapping slices.

An alternative to the CRNN architecture above would be to concatenate the feature vectors as more channels. Then they would be processed by 2D convolutions in a simple feed-forward network instead of a recurrent one. There are, however, benefits to the CRNN architecture over a simple feed-forward architecture. For instance, the CRNN architecture benefits from parameter sharing and, hence, is more compact than a comparable feed-forward architecture.

The method may comprise the step of voxelizing the 3D structure; that is, generating the voxel representation from another representation of the 3D structure (such as a point cloud or surface mesh representation etc.), in order to extract the horizontal slices. Alternatively, the method may be applied to an existing voxel representation that has been generated externally. Note the references to “receiving” a voxel representation case include the case of a voxel representation received internally from some voxelization component, as well as from an external source.

As noted, an application of the encoder architecture is to support symmetry detection. In such applications, the 3D structure comprises at least one object that is known or assumed to exhibit some level of reflective symmetry, about a 2D symmetry plane (the location and orientation of which is unknown).

In such embodiments, the second feature tensor of each slice may be processed in a decoder, in order to compute multiple predicted offsets for multiple portions of the slice, the predicted offset for each portion of the slice being a predicted offset between that portion of the slice and an unknown 2D symmetry plane.

A third aspect herein is directed to a novel form of symmetry detection.

A computer-implemented method of detecting 3D object symmetry, in accordance with the third aspect, comprises:
receiving 3D data comprising a full or partial view of a 3D object within a 3D volume, the 3D object exhibiting reflective symmetry about an unknown 2D symmetry plane;
voxelizing the 3D volume, to encode the view of the 3D object in a voxel array;
processing the voxel array in a convolutional neural network, in order to generate an output tensor, each element of which corresponds to a portion of the 3D volume, and contains a predicted offset of that portion from the unknown 2D symmetry plane.

The symmetry detection of the third aspect can be applied to 3D objects that are arbitrarily rotated in 3D space.

In embodiments, the symmetry detection of the third aspect may leverage the encoder architecture of the second aspect, so as not to rely on computationally expensive 3D convolutions.

In embodiments third aspect, or the second aspect when applied to symmetry detection, each element of the output tensor may correspond to one of the voxels of the input tensor, the predicted offset being a predicted offset between that voxel and the unknown 2D symmetry plane.

The method may comprise aggregating the predicted offsets across all of the slices, in order to compute an estimated location and orientation of the unknown symmetry plane. For example, the plane may be computed as a set of plane parameters, and a least-squares method may be used to solve for the plane parameters.

The offset may, for example, take the form a 3D vector giving the location of the closest point lying on the symmetry plane with respect to the portion of the slice for which the offset is predicted.

Embodiments will now be described, in which the above aspects are combined to provide a mechanism for refining the perception estimates of the orientations of vehicles using the idea that vehicles are symmetric in shape (left/right). The method is general and can work with any roughly symmetric shaped objects.

Further aspects provide a computer system comprising one or more computers configured to implement the method of any of the above aspects or any embodiment thereof, and executable program instructions for programming a computer system to implement the same.

The method steps above can be performed using trained ML models, and/or as part of the training method(s) themselves. A further aspect herein is directed to training methods for training the applicable ML models to implement such steps.

### BRIEF DESCRIPTION OF FIGURES

For a better understanding of the present invention, and to show how embodiments of the same may be put into effect, reference is made by way of example only to the following Figures in which:

FIG. 1 shows a schematic overview of a pipeline for estimating symmetry planes from 3D data;

FIG. 1A shows a schematic block diagram of a method of refining bounding box detections based on estimated symmetry planes;

FIG. 2 shows a bird's eye view of a driving scene including lidar sensor data overlaid with bounding box detections;

FIG. 3 shows a schematic function block diagram of an autonomous vehicle stack;

FIG. 4 shows a schematic overview of an autonomous vehicle testing paradigm; and

FIG. 5 shows a schematic block diagram of a scenario extraction pipeline.

### DETAILED DESCRIPTION

Many man-made objects are characterised by a shape that is symmetric along one or more planar directions. Estimating the location and orientation of such symmetry planes can be an important proxy for many tasks such as: estimating the overall orientation of an object of interest (when observed from an unknown viewpoint); or performing shape completion, where a partial scan of an object (obtained, for example, by a 3D sensor such as a stereo camera or a LiDAR scanner) is reflected across the estimated symmetry plane in order to obtain a more detailed shape that can be used in downstream tasks. Described below is a method for estimating the parameters of symmetry planes of 3D objects via a recurrent deep voting scheme followed by a differentiable least squares regression step, allowing for accurate and fast processing of both full and partial scans of symmetric objects. This method has an accuracy comparable to state-of-the-art approaches on the task of planar reflective symmetry estimation from full 3D models on a standard benchmark; and provides accurate results on a novel task concerning the estimation of the symmetry parameters from partial scans of objects contained within both standard datasets (ShapeNet) and real-world data (from the well-known nuScenes dataset).

### Symmetry Detection

Processing 3D objects has proven useful (and, many times, necessary) in many scenarios, including robot grasping, autonomous driving, navigation and mapping. Systems deployed within these fields often encounter many subproblems that have to be tackled independently, but whose solution is crucial to the behaviour of the whole system. Such problems include tasks such as object detection, pose estimation, shape completion and matching, and many others. Symmetry detection, while commonly investigated in 2D scenarios [7, 12, 16, 19, 41, 52], has gained more attention recently in 3D vision [18].

Found in natural and man-made structures, symmetry appears locally and often also globally within objects. The methods described herein focus on global symmetry. In the present context, an object is considered symmetric if there is at least one plane such that reflecting the object across the plane results in the same object; otherwise, the object is considered asymmetric. Most of the existing symmetry detection methods focus on the 2D case (i.e. detecting symmetry in images). More recent methods focus also on the 3D case [13, 14, 20, 21, 36], with some assuming that the objects are lying on a known plane [2, 24, 29]. Assuming that the objects of interest are lying on such a plane reduces the degrees of freedom of the symmetry parameters to estimate, thus simplifying the process of finding a solution to the task. However, this also reduces the degree to which the model can generalize to real data. Conversely, the methods described herein are designed to work for objects arbitrarily rotated in the 3D space.

To allow for arbitrary rotations, instead of processing the whole input at once, different parts of the input are analysed separately in a sequential manner along the vertical direction, similarly to how a scanner would observe the world. To process sequential data, a recurrent architecture (RNN) is used and the input is partitioned along the height dimension to get a sequence of slices. While RNN-based architectures have been extensively used in speech processing, machine translation, caption generation and related natural language processing tasks, they have also been successfully applied in computer vision tasks. For instance, they have been used for object detection [25], semantic segmentation [50], motion tracking and trajectory forecasting [1, 34]. The model is equipped with a convolutional gated recurrent unit (ConvGRU) network, a type of an RNN, to help it predict planes when the objects are arbitrarily rotated in 3D space. In this implementation, the GRU observes different slices of the input point cloud each time. In other words, each slice is considered as a time step. For each slice, the network regresses the per-pixel locations of the symmetry plane relative to the slice itself. These predictions then allow us to estimate the parameters of the symmetry plane by minimizing a differentiable least-squares system 11 (inspired by [40]).

As described below, this approach works when applied to full 3D models of objects contained in a standard dataset (ShapeNet [4]), which was recently adapted to benchmark the task of planar reflective symmetry estimation [20]. It is also demonstrated below that this method can be applied to self-obstructed or partially occluded objects, such as those captured by a sensor (e.g. a LiDAR or stereo camera) in the real-world. By using the detected symmetry planes to refine bounding boxes output by a state-of-the-art 3D object detector, it is empirically determined that it is possible to reduce the average angular error of such boxes.

As mentioned earlier, the object detection task is a crucial component that is often one of the first steps of many complex pipelines in robotic navigation or grasping, autonomous driving, unsupervised or automatic labelling/annotation; therefore improving the accuracy of the detections can significantly increase the chance of success of each pipeline as a whole.

Features of the described embodiments include:
A network based on Convolutional Gated Recurrent Units allowing the regression of 3D offsets indicating where a reflective symmetry plane would lie relatively to a regularly sampled grid of points on the object model or partial scan;
A differentiable constrained least-squares solver which is used to estimate the parameters of a plane passing through the points determined by the 3D offsets predicted by the ConvGRU network; and
A method that uses the predicted symmetry planes to refine the boxes output by a 3D object detector, improving its accuracy.

There are various ways in which symmetry can be detected, but most 3D approaches can be categorized as either purely geometric or data-driven. For instance, an early geometric method [39] used a hierarchical algorithm to test a 3D object for reflective, axial and spherical symmetries. The idea behind the algorithm is that the object cannot have spherical symmetry without having axial symmetry, which in turn implies the object must also have reflective symmetries. They designed a bottom-up method validating each type of symmetry (via a scoring function) and returning the most general one displayed by the object. More recent geometric methods [14, 15] use an Iterative Closest Point (ICP)-based method that iteratively improves the candidate symmetry plane based on the symmetric correspondences found at each iteration step. The advantage of purely geometric approaches is that they do not require any prior information about the objects. However, they are generally designed to work with objects that do not have significant missing parts, as they need most of the visible points to have matching reflected points, in order to compute the value of the scoring function driving the iteration.

This issue is typically addressed by data-driven methods which introduce a shape prior; for example, [38] introduces an explicit database. Whilst this can be effective, it has the downside that the database must contain an object similar to the one that is being used for symmetry detection for it to work. It can also be rather slow. An alternative to introducing an explicit shape prior is adopting a deep learning approach to symmetry detection [20, 36], where a network effectively acts as an implicit prior. In this case, a collection of objects is needed to learn a set of parameters and generalise to unseen objects. While data-driven techniques need some time to learn the adequate parameters, they have a better chance of dealing with incomplete objects, such as self-obstructed objects seen from a single camera pose. A recent example of a deep learning data-driven method is SymmetryNet [36], which uses supervision to predict symmetry planes given a single RGB-D image for each 3D object (i.e. self-occluded objects). It relies on PointNet [6] to obtain point-wise geometric features, which in turn are used to make point-wise symmetry predictions that are finally aggregated, yielding the plane parameters. Another example of a deep learning approach is PRS-Net [20], which directly regresses the symmetry planes of an object in a fully unsupervised way. Unlike [36], PRS-Net is a voxel-based method and, hence, it is restricted to lower resolutions due to the high computational cost of the 3D convolutions. The authors used a subset of 3D objects from ShapeNet [4] to train their deep learning model and, for evaluation, they manually inspected and labelled 1000 objects. Prior to PRS-Net, the ICCV Challenge: Detecting Symmetry in the Wild created a subset of ShapeNet [4] and then labelled it. In spite of these efforts, currently there is no universally agreed standard dataset for this task.

Apart from the definition of a benchmark to evaluate symmetry estimation methods, just as in many other tasks, the choice of how to represent and process the data is also critical for detecting symmetries. While 2D symmetry detection models typically use 2D convolutions to process the input images [7, 12, 19], in 3D cases there are several approaches that can be used to represent the input efficiently. As there are not so many papers on symmetry detection that rely on deep learning in 3D space, inspiration is drawn from the object detection literature. For example, object detection methods [35, 48] based on PointNet [6] process pointclouds directly, treating them as a collections of unordered points. Another approach is to discretize the 3D input into voxels and use 3D convolutions to further process it, which is computationally expensive and does not allow working with higher resolutions [17,45,51]. Alternatively, the pointclouds can be projected onto a plane, allowing working with 2D convolutions and, hence, being more efficient than the voxelization methods using 3D convolutions. Typically, range (or panoramic) view [42, 43] and bird's eye view (BEV) projections [8, 28, 46, 47] are used. While both projection types have the advantage that they work with 2D convolutions, the former often distorts the object's shape. An example method described in further detail below uses a bird's eye view representation, as it is more efficient to use 2D instead of 3D convolutions.

### Architecture Overview

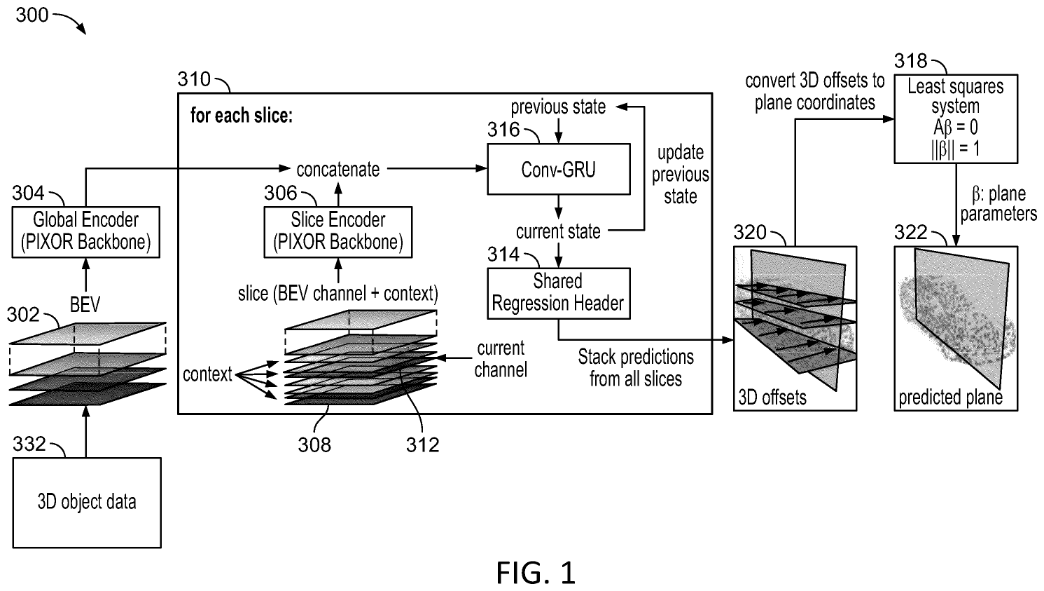

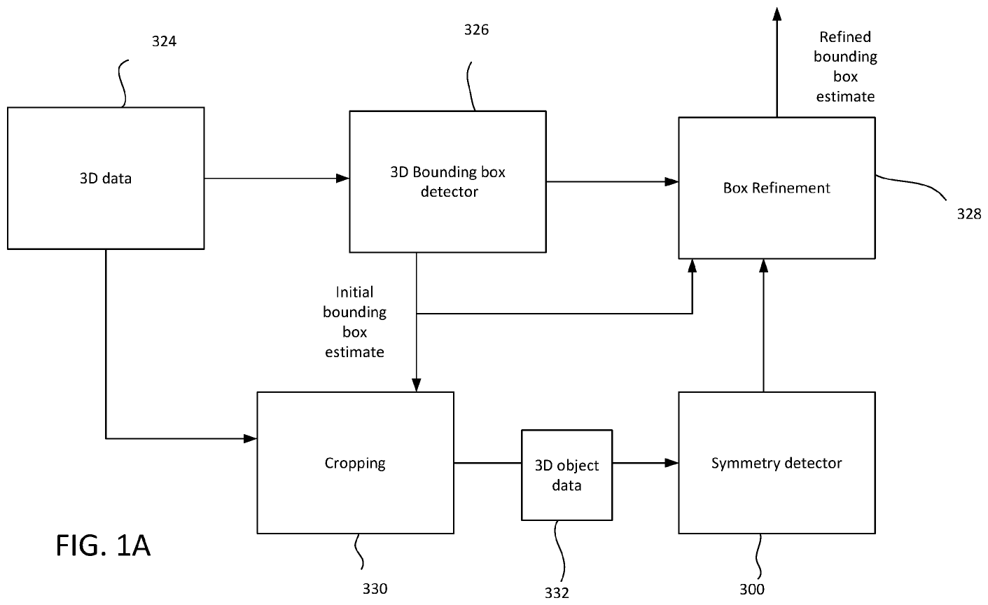

FIG. 1 shows a schematic overview of an example pipeline for estimating symmetry planes from 3D point cloud data, for example lidar or radar data. This pipeline is referred to herein as a symmetry detector 300. As mentioned above, 3D data 332 representing a symmetric object (or a partial view thereof) in 3D space is projected in this example implementation to a set of 2D slices, with each slice being a bird's eye view (BEV) voxelised representation corresponding to a different vertical height. The multiple BEV slices 302 are processed together by a global encoder 304 which generates a feature vector for the full 3D object. A second per-slice encoder is applied to each slice of the input 302 to generate a separate feature vector for each slice. These may be concatenated with the global feature vector to generate a concatenated feature vector for each slice. The feature vectors are then provided as input to a 2D convolutional gated recurrent unit (ConvGRU) 316 that, for each slice, computes a state and outputs that state to a shared regression header to regress per-pixel 3D offsets indicating where the symmetry plane lies, relatively to each slice pixel, as described in further detail below. Once the 3D offsets 320 have been regressed for all slices, a voting algorithm is deployed to estimate the absolute 3D coordinates of points expected to lie on the symmetry plane; those coordinates are then used to solve a constrained least squares system 318 to estimate the parameters of the plane 322 itself.

FIG. 1A shows an example detection refinement technique that uses the symmetry planes estimated using the system of FIG. 1 to improve bounding box detections made by an object detector, for example as part of a perception component of an autonomous vehicle stack. As shown in FIG. 1A, at a first stage, a 3D bounding box detector 326 receives 3D data 324, such as lidar point clouds, and computes an initial bounding box estimate for the object or objects captured in the 3D data, having one initial bounding box for each object. The 3D data is separately passed to a cropping component 330 to crop the 3D data for each object to be passed to the symmetry detector 300 based on the initial bounding box estimate produced by the 3D bounding box detector 326, such that the symmetry detector 300 receives a cropped 3D data input 332 for each object for which symmetry detection is to be performed. The symmetry detector 300 determines an estimated plane of symmetry for each object as described briefly above, and in further detail below. The initial bounding box estimate is passed to a box refinement component, and the computed plane of symmetry is used by the box refinement component to compute a refined box. This refinement is referred to herein as the second stage in the bounding box detection, where the first stage is the application of the 3D bounding box detector 326 to generate an initial bounding box estimate.

The components of the symmetry detector 300, as shown in FIG. 1 will now be described in further detail.

The method shown in FIG. 1 performs symmetry detection from 3D objects: either synthetic models or partial views from ShapeNet [4], or real-world data depicting partial scans of symmetric objects (e.g. cars) such as those contained in the nuScenes dataset [3] or gathered from LiDAR scans during autonomous driving missions. The architecture used for this model consists of two encoders (global encoder 302 and per-slice encoder 306), a convolutional gated recurrent unit (ConvGRU) component 316 and a decoder, followed by a voting module and a least-squares regression module 318; as shown in FIG. 1. ‘Slice’ is used herein to refer to a chunk of contiguous channels along the height component of the BEV voxelisation. In what follows symmetry planes are denoted by [symbol] =(n, d), where n=(a, b, c) is a unit vector defining the normal of the plane, d is the plane's distance from the origin, and ax+by +cz=d for every point p=(x, y, z) lying on the plane [symbol] . Equation 1 describes the reflection of a general point p∈ [symbol] across a symmetry plane [symbol] :

$${R}_{𝒮} ( p ) = p - 2 n ( p \cdot n - d ) \qquad ( 1 )$$

### Bird's Eye View Encoding

A Bird's Eye View projection is used to discretise sparse 3D pointclouds into a denser representation 302. An axis-aligned occupancy grid (of size H×D×W) is created by voxelising the space contained within a unit box centred on the origin, then setting to 0 unoccupied voxels and to 1 voxels containing at least one point. A pre-processing step is applied to ensure that the points fed as input to the algorithm fit in such a unit box by normalising their coordinates. While ShapeNet (already normalised) models do not require this pre-processing, the step is beneficial when processing real data to refine object detection outputs; in this case the extents of the unrefined 3D bounding box are used to scale the coordinates.

The BEV representation is best suited to be processed by 2D convolutions over “pixels” located on a plane parallel to the ground (horizontal) plane. Nevertheless, the information coming from the third dimension is not lost as all the voxels located above each ground-plane pixel are considered as H separate channels that are fed as input to the 2D convolutions. As anticipated above, in addition to feeding all the H height channels to a single 2D convolution, in a global fashion, the BEV representation can also be sliced in order to obtain views of a limited region of the 3D space. These views can be fed to independent feature encoders or to the same encoder 306 over multiple timesteps in a recurrent approach, as shown in FIG. 1. More specifically, N channels of interest C={cᵢ: i∈{1, . . . , N}} can be chosen over the height dimension of the voxelisation and, given a context of size K for every slice, the height channels in {cᵢ−K, . . . , cᵢ+K} can be selected to form a tensor of size (2K+1)×D×W that can be fed to a per-slice encoder 306.

### Encoders

The BEV input 302 is passed initially to the global encoder 304. As 3D convolutions are not used, processing the information from all height channels at once yields only a coarse representation of the spatial relations of the 3D data. Therefore, an extra component is needed to take care of the finer details in the data: an encoder 306 that sees contiguous chunks of the BEV input, after slicing it along the height channels, as mentioned in the previous section. This component is referred to herein as the slice encoder 306. Both encoders are based on PIXOR's [47] backbone network, which uses 2D convolutions and outputs both low and high-resolution convolutional feature maps. In this example implementation, only the high-resolution features are used, which are 4 times smaller than the input. For more details, see subsection 3.2.1 of [47]. The global 304 and slice 306 encoders are complementary. The benefit of the two encoders has been demonstrated empirically. For each of the N slices generated from the BEV input 302, the output of the slice encoder 306 is concatenated to the output of the global encoder 304. The result then is fed to a sequence of ConvGRUs 316, described below.

### ConvGRU

If the object has a symmetry plane perpendicular to the ground plane, then it would be enough to predict a single set of 3D offsets (i.e. from a single slice corresponding to the overall object) as a single vertical plane can pass through a line. On the other hand, for objects that have been arbitrarily rotated fitting a plane through a single line coming from a single slice is not possible. Thus, line predictions would need to be made at different heights along the object in order to get a set of lines through which we could fit a plane.

As the chunks of BEV channels are processed sequentially, predictions should be computed at each slice, keeping into account the information gained from processing the previous slices as well. An appropriate structure that can do this type of processing is a recurrent neural network (RNN). One successful implementation of RNNs is the long short-term memory (LSTM) [23] network, which has been traditionally used for efficiently processing sequences while keeping track of long-term dependencies within the sequence. Another LSTM-based structure is the gated recurrent unit (GRU) [9] network, which has fewer parameters than an LSTM (and, hence, fewer computations) but a similar purpose. GRUs are chosen in the present example over the LSTMs as the former is more compact, but comparable with the latter in terms of performance [11]. However, the present techniques may also be applied to other types of recurrent neural network architectures, including LSTM networks.

To account for the higher dimensionality of the input to the GRUs—sequences of 2D feature maps 320 instead of the traditionally used 1D sequences—the GRU is adapted. Therefore, the update and reset gates are changed to perform 2D convolutions rather than dot products, similarly to [10, 37], obtaining a Convolutional GRU (ConvGRU). Equations 2-5 describe the operations within the update gate uₜ, reset gate rₜ and hidden state hₜ of the ConvGRU. Subscript t is used to mark the time steps, i.e. slices in our case; b_{(.)} are biases; W_{(.)} and V_{(.)} are matrices used by 2D convolutions. The notation ⊙ is used for element-wise multiplication.

$${u}_{t} = σ ( {W}_{u} * {x}_{t} + {V}_{u} * {h}_{t - 1} + {b}_{u} ) \qquad ( 2 )$$

$${r}_{t} = σ ( {W}_{r} * {x}_{t} + {V}_{r} * {h}_{t - 1} + {b}_{r} ) \qquad ( 3 )$$

$${\hat{h}}_{t} = tanh ( {W}_{h} * {x}_{t} + {V}_{h} * ( {r}_{t} ⊙ {h}_{t - 1} ) + {b}_{h} ) \qquad ( 4 )$$

$${h}_{t} = ( 1 - {u}_{t} ) ⊙ h + {u}_{t} ⊙ {\hat{h}}_{t} \qquad ( 5 )$$

Before processing the first slice, each hidden state is initialised by a separate 3×3 convolutional layer processing the output of the global encoder, followed by group normalization [44] and a rectified linear unit (ReLU) activation function. FIG. 1 shows a simplified version of the architecture using a single ConvGRU layer 316. In a stack of ConvGRUs the first layer takes as input its previous hidden state along with the concatenated global and per-slice encoder outputs. Then, the second layer receives its previous hidden state and the previous ConvGRU layer's output, and so on. The hidden state output by the last ConvGRU layer 316 for each time step (i.e. slice) is passed to a decoder 314, shared between the slices, that predicts the corresponding 3D offsets. The decoder 314 is also referred to as a shared regression header in FIG. 1.

The decoder 314 consists of five 3×3 convolutional layers, where the first four are followed by group normalization and ReLU and are applied in sequential order. The output of the fourth layer is passed to a final convolutional layer yielding the 3D offsets. Each 3D offset indicates the relative location of the symmetry plane with respect to each pixel element in the slice. Finally, after all the slices have been processed, the offsets are stacked into a single tensor 320 for further processing.

Computing Symmetry Planes from 3D Offsets

As mentioned above, the decoder 314 in the example symmetry detection network produces 3D offsets 320, indicating where the symmetry plane for the object being observed would lie relatively to the voxels in each slice. Those relative offsets 320 are added to their corresponding voxel coordinates to obtain world-space coordinates of points lying on the symmetry plane. We denote those as a set of N points P={pᵢ: i∈{1, . . . , N}}.

In order to find the optimal symmetry plane [symbol] =(\hat{n},\hat{d}) passing through the points in P we solve a least squares system of the form:

$$A β = 0 \qquad ( 6 )$$

where A is a N×4 matrix obtained by stacking the homogeneous representation of the points in P, i.e. {[pᵢ; 1]: i∈{1, . . . , N}}; and B are the parameters of the plane [symbol] =(\hat{n},\hat{d})=(â, \hat{b}, ĉ, \hat{d}). Note that in solving this system the following are ignored:
all the points computed by adding the predicted offsets to the coordinates of a voxel that was originally empty in the BEV representation,
those that (after adding the predicted offset) lie outside the extents of the BEV grid (i.e. those outside the range [−0.5,0.5]³).

A constraint is also introduced to the parameters of the system to avoid the trivial solution of β=0, instead solving:

$$A β = 0 \qquad ( 7 )$$

$$‖ β ‖ = 1 \qquad ( 8 )$$

using the technique from Appendix A5 in [22]. It is worthwhile noting that estimating the parameters of the plane remains a fully differentiable operation since this approach to computing β simply requires the last column of V from the singular value decomposition (SVD) of A. Thus, we can backpropagate the losses described in the next subsection through it. Finally, as our definition of the plane [symbol] assumes that the normal component of the plane is a unit vector, β is scaled by the norm of (â, \hat{b}, ĉ).

### Losses

In one training method, described in further detail below, a mix of supervised and unsupervised training is used to train the network described above and shown in FIG. 1. For supervision, a set of ground truth symmetry planes are used to compute two losses: one based on the offsets predicted by the model and another one based on the plane parameters. In the unsupervised case, a geometric loss is used to evaluate the quality of the predicted plane.

Offsets Loss. This loss is used in the supervised part of the training process. Given the world-space coordinates p of the center of each voxel in the N channels selected when slicing the BEV representation, we can easily compute their relative offset y from the ground truth symmetry plane [symbol] =(n; d) using the signed point-to-plane distance:

$$y = - ( np - d ) n \qquad ( 9 )$$

As the decoder predicts 3D offsets (denoted by ŷ, see above), an LI loss is used to train the network for this task:

$$OL = {L}_{1} ( \hat{y} , y ) \qquad ( 10 )$$

Ground Truth Error. Taking the form of the metric in Equation 9 of [20], Equation 11 describes the sum of squared element-wise distances between the predicted and ground truth planes, [symbol] and [symbol] .

$$\begin{matrix}GTE = {( \hat{a} - a )}^{2} + {( \hat{b} - b )}^{2} + {( \hat{c} - c )}^{2} + {( \hat{d} - d )}^{2} \\ = {( \hat{𝒮} - 𝒮 )}^{T} ( \hat{𝒮} - 𝒮 )\end{matrix} \qquad ( 11 )$$

Note that, as some objects in the dataset may have multiple valid symmetry planes, the GTE is computed for the ground truth plane closest to the predicted one only.

Symmetry Distance Error. Given a set of points O (randomly sampled from an object Q) and a predicted plane [symbol] , Equation 12 calculates for each point p∈O the squared distance between [symbol] (p) (the reflection of p across [symbol] ) and its corresponding closest point q∈Q, then averages these distances to obtain the Symmetry Distance Error (SDE, as defined in [20]).

$$SDE = \frac{1}{\vert O \vert} {\sum }_{p ∈ O} {min}_{q ∈ Q} {‖ {R}_{\hat{𝒮}} ( p ) - q ‖}^{2} \qquad ( 12 )$$

As this does not require knowledge of the ground truth plane, this loss can be used during unsupervised training.

### Experimental Evaluation

Described below are the datasets used to evaluate the approach described above, and further details are provided on the implementation of the symmetry detection network and on the procedure followed in order to train the models. The accuracy of the estimated symmetry planes is evaluated for both full synthetic object models (comparing the results of the present methods with those obtained by other methods in literature) and realistic partial views of them. Finally, the approach is integrated with a state-of-the-art 3D object detector into a real-world pipeline in order to refine the 3D bounding boxes output by the detector. It is shown that the orientation of such refined boxes is indeed better than the orientation of the raw boxes output by the detector, thus being able to provide better information to downstream tasks such as perception, manipulation, planning, and navigation.

### Datasets

ShapeNetCore, a subset of ShapeNet [4], was used in experiments, split into training and validation partitions as in [20] accounting for 80% and 20% of the total 51,300 models, respectively. ShapeNetCore is a collection of synthetic 3D meshes including 55 object classes such as: cars, airplanes, tables, chairs, etc. As the objects contained in the dataset are mostly axis-aligned and centered on the origin, the models were augmented by applying random rotations during training and validation. To evaluate the above-described approach on partial views of the very same objects, PyTorch3D's [33] algorithms were used to rasterise the object models from random viewpoints and fed the resulting partial pointclouds to the above method. From the validation partition the 1000 objects provided by [20] were held out and used for testing.

nuScenes [3] was used to assess the performance of the described methods on real-world data. This is a large-scale dataset for autonomous driving, containing 1000 scenes of annotated driving scenarios, each ˜20 s long. It provides LiDAR sweeps and annotated bounding boxes for multiple object categories and, among other things, standardised training/validation/testing splits as well as a toolkit to evaluate the performance of object detectors using predefined metrics. In evaluation the LiDAR sweeps were used, together with the ground truth training/validation annotations to train the symmetry detector, which is then used to refine the boxes output by one of the top-performing 3D object detectors [49].

### Implementation Details

In the present example implementation, the 3D occupancy grid used to generate the BEV representation fed to the network is a unit box centered on the origin, with coordinates ranging from −0.5 to 0.5 in each direction. The 3D space is divided into 16×64×64 voxels. Deliberately focusing the slice encoder and the recurrent component of the network on the central part of the volume, a slice encoder input is constructed comprising 4 slices centred at the height channels C={4,6,8,10}. Additionally, adjacent slices are allowed to overlap over one channel of the BEV representation by using a context size K=1. Adam is used as an optimizer, with an initial learning rate of 0.001, later reduced by a factor of 0.5 when the validation loss stops improving.

### Training Protocol

Training with synthetic data: As the described method is intended to apply to general sparse 3D object representations, it is designed to work with pointclouds. The ShapeNetCore dataset contains meshes, so sparse pointclouds are generated by sampling points uniformly across the triangular faces. However, the models are synthetic, thus they sometimes contain internal/occluded faces as well, which may not be symmetric (e.g. the steering wheel of a car). To overcome this issue, the external surface of each model is identified by rasterising the sampled pointcloud from six different camera poses (one from above the object, one from under the object and four uniform views with no elevation) and only the points visible from at least one camera pose are selected for further processing. For efficiency, PyTorch3D's [33] rasteriser is used to do so ahead of time.

Two instances of the architecture described above with reference to FIG. 1 are then trained: full and partial-view models. The former is tasked with estimating symmetry planes for full 3D objects, to be able to directly compare the performance of the described method with other methods in literature. The latter is trained to estimate symmetry planes for objects for which only a partial view is available. In this case, the partial views are obtained (once again, using PyTorch3D's rasteriser) from randomly generated viewpoints. This model is used to inform the design choices required to deploy the method on real data, which is described later.

In both cases, the training procedure starts with an initial 200-epoch phase which uses the full pointclouds and is fully supervised, relying on the Offsets Loss described above. Then, depending on whether training a model for estimating symmetry planes for full 3D objects or partial views, the approach branches into two different directions for 200 more training epochs. In training of machine learning models, an epoch typically refers to a single pass of the full training dataset. For complete objects we continue the training procedure using an unsupervised loss (SDE). On the other hand, for partial object pointclouds the model cannot be trained in an unsupervised manner, as there would be no counterpart matching the reflection of most visible points used when computing SDE. Hence, the training is continued with supervision and both Offsets Loss and GTE are employed on the partial views generated as described above.

Training with real data: To facilitate the deployment of the method in a practical context, the model is trained for the estimation of symmetry planes for vehicles, as they typically have a single symmetry plane running along the length of the object. To evaluate the described approach on data captured in a real-world scenario nuScenes' LiDAR sweeps are used. The authors of the dataset provide ground truth object annotations for both the training and validation scenes in the form of six degrees of freedom bounding boxes. Such boxes are used to crop each LiDAR sweep in order to obtain a pointcloud for each annotated vehicle. As the sweeps are obtained from a moving vehicle, each crop is translated to be centred on the origin. Then the coordinates are scaled according to the length of the bounding box to make sure the points in the crop fit in a unit box, as that's what is used to create the BEV representation of the input. Finally, the model is trained in a manner similar to the one described previously for partial views, for a total of 200 epochs (as more data is available, it is not necessary to train for 400 epochs).

For testing, on the other hand, the bounding boxes output by the implementation of the CenterPoint detector [49] are used to crop the LiDAR sweeps. Each such crop is then fed to the described symmetry detection method and the predicted symmetry plane is used to update the pose of the corresponding box. Specifically, a rigid refinement transform is computed which maps the box output by the detector to a box having the predicted symmetry plane running along the middle, and this transform is applied to the pose of the detection.

### Results

Results on synthetic data: To evaluate the performance of the described symmetry detection method on full 3D objects from ShapeNet the testing split and evaluation metrics defined in [20] are used. GTE and SDE (see above) are the losses used to compare with several other methods in literature: Principal Component Analysis (as implemented in [20]); Oriented Bounding Box [5]; the methods by Kazhdan et al. [26], Martinet et al. [30], Mitra et al. [31], Podolak et al. [32], Korman et al. [27], and PRS-Net by Gao et al. [20].

As shown in Table 1, the method described above outperforms several of the competing approaches and reaches an accuracy comparable to the best methods on the SDE metric. As for the GTE metric, the gap between the results for the present method and the current state-of-the-art approach can be attributed to the difference in the methods' designs. While PRS-Net is devised to predict up to three reflective symmetry planes for each object, the present method outputs a single plane as that is enough for the targeted real-world task. The present techniques can be extended to the multiple symmetry plane scenario.

TABLE 1
Performance of our method compared with other methods in literature evaluated using the Ground Truth Error
and Symmetry Distance Error metrics on the 1000 objects part of the ShapeNet test set as defined by the
PRS-Net paper [20]. For our method, we show both the results obtained by processing the full object
models (directly comparable with the other results in the table), as well as the results we obtain by
estimating symmetry planes for partial views of the same objects captured from random viewpoints.

| | | Oriented | Kazhdan | Martinet | Mitra | PRST | Korman | PRS- | | |
|---|---|---|---|---|---|---|---|---|---|---|
| | PCA | Bounding | et. al. | et. al. | et. al. | [32] with | et. al. | Net | | Ours |
| Metric | [20] | Box [5] | [26] | [30] | [31] | GEDT | [27] | [20] | Ours | (Partial) |
| GTE (×10⁻²) | 2.41 | 1.24 | 0.17 | 13.6 | 52.1 | 3.97 | 19.2 | 0.11 | 9.5 | 19.9 |
| SDE (×10⁻⁴) | 3.32 | 1.25 | 0.897 | 3.95 | 14.2 | 1.60 | 1.75 | 0.861 | 1.26 | 5.02 |

On the other hand, differently from the alternative methods mentioned above, the present approach can estimate reflective symmetry planes from objects for which only a partial point cloud is available, analogously to the data that would be returned by a sensor observing an object in the real world. Results on this task are reported in the last column of Table 1, where the model is fed clouds generated as described for training with synthetic data above. Note that, although partial pointclouds are used as input to the network, in the evaluation SDE was computed on full 3D objects, as computing this error for a partial cloud would be meaningless. The numbers show that the proposed approach can indeed handle partially observed objects; albeit with a slightly lower—but not significantly different—performance. These results are encouraging, as they show that the present approach, based on a recurrent network followed by a least-squares solver, can handle objects which are missing a significant number of points. This clue is exploited in order to deploy the system as part of a real-world pipeline, as described for training on real data above.

Results on real data: After training an instance of the present model on data from the nuScenes [3] dataset, it was used to refine the 3D bounding boxes output by a LiDAR object detector [49]. In practical scenarios it is not enough to identify the location of objects surrounding the sensor platform, as for tasks such as navigation and planning it is important to know the accurate heading of neighbouring detections as that affects their future pose. This is especially relevant when both the sensing platform and the detected targets are moving at relatively high speeds, as small orientation errors can contribute to large errors in the forecasted state of the system.

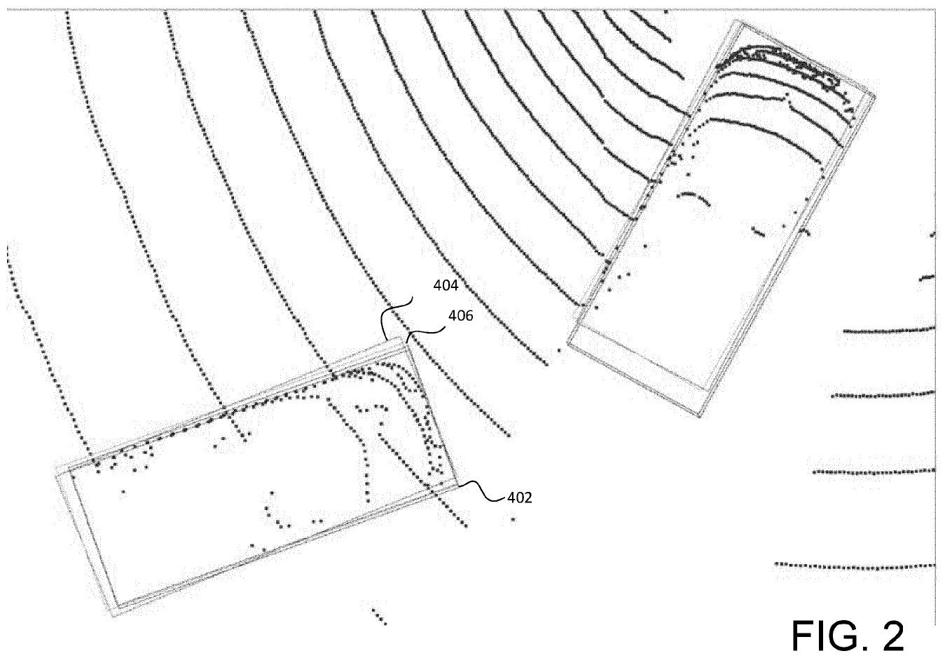

FIG. 2 illustrates the effects of using the estimated symmetry plane to update vehicle detections. FIG. 2 shows a zoomed region of a LiDAR sweep which is part of the nuScenes dataset used in training as described above. Two objects are shown, each associated with three bounding boxes. A first bounding box 402 is the ground truth bounding box for that object. A second bounding box 404 is the bounding box output by the bounding box detector. In the present example, this is based on the CenterPoint detector [49], but other bounding box detection methods may be used. The third bounding box 406 is the bounding box determined after refinement, i.e. after reorienting the pose of the predicted bounding box based on the symmetry plane determined based on the method described above with reference to FIG. 1.

Quantitatively, Table 2 compares the symmetry refinement on the nuScenes evaluation metrics to the raw output of the baseline detector. The main translation and scale metrics are not affected by the refinement—which is expected, since symmetry plane refinement mainly affects the orientation of each box. On the other hand, the Mean Average Orientation Error for objects of the cars category is improved by ˜6%, thus allowing better decision making in downstream tasks.

TABLE 2
Effect of applying the proposed symmetry estimation approach
as a refinement step for a state-of-the-art 3D object detector.
We evaluated the performance of the baseline approach (our
re-implementation of CenterPoint [49]) and our post-processing
on the nuScenes dataset [3]. In this evaluation we only
considered ground truth object annotations and detections
assigned to the “car” category, and we can see that
using detected symmetries to refine the 3D bounding boxes
can improve the mAOE metric by more than 6%.

| | | mATE | mASE | mAOE |
|---|---|---|---|---|
| | mAP | (m) | (1-IOU) | (rad) |
| CenterPoint [49] | 0.837 | 0.189 | 0.156 | 0.147 |
| (our impl) | | | | |
| CenterPoint + | 0.836 | 0.188 | 0.155 | 0.138 |
| Symmetry PP | | | | |

Described herein is a method that can be used to estimate planar reflective symmetry planes from 3D objects. The proposed approach relies on the following steps. First, a target pointcloud is voxelised in a top-down Bird's Eye View representation, which is then sliced along the height channels. The resulting slices are iteratively fed to a recurrent network in order to regress 3D offsets expressing where the symmetry plane would lie relatively to the voxels in each slice. Then, those 3D offsets are used to vote for the absolute location of points lying on the symmetry plane. Finally, a fully differentiable linear system is deployed to solve for the parameters of the plane equation. This method can be applied to pointclouds obtained from both complete 3D objects and their partial views captured from arbitrary viewpoints. The latter is important because, in real-life scenarios, sensors mounted on robotic platforms or autonomous vehicles are not able to observe the full extents of target objects, but are limited to capturing information from a single (visible) side of them. This could be overcome by moving the sensor around the object and capturing data from multiple viewpoints, but it is not efficient and would still require planning the movements of the sensor without knowing the full extents of the target. Conversely, being able to estimate the location of symmetry planes from only a view of an object can help in determining its extents as well as in reconstructing an approximation of the full 3D model, by reflecting the visible points across the detected plane. Whilst a single symmetry plane is considered in the above examples, the described techniques can be extended to handle multiple symmetry planes for each object, which can be useful in scenarios where the targets might have more regular shapes (e.g. objects that can be found in indoor environments such as tables or boxes).

By comparing with the performance of other methods in literature, this approach provides good results on both full and partial pointclouds obtained from synthetic objects part of a standard dataset. It is also shown above that the proposed approach can indeed be deployed satisfactorily in a real-world 3D object detection pipeline as a post-processing step that increases the detection accuracy by refining the detected boxes. This can help by improving the performance of several subsequent tasks—such as segmentation, navigation, planning, grasping or trajectory forecasting—which are typically part of robotics or autonomous driving pipelines.

The embodiments described above are not exhaustive. For example, will be appreciated that knowledge gained through symmetry detection can be used to inform 3D object detection for symmetric objects in other ways. For example, whilst the above examples consider a symmetry-informed transformation of an initial 3D bounding box, as noted, symmetry detection could be used to inform other facets of object detection, such as the selection of a final bounding box from multiple candidate boxes. As noted above, another symmetry-informed pose detection method runs the described symmetry detection method on top of every proposal bounding box generated by a two stage detector (for example Faster-RCNN), and uses the estimated plane when scoring and choosing the boxes to output. In such embodiments, a bounding box detector computes multiple candidate (proposed) boxes (or other bounding objects) and the criterion (or one of the criteria) for ranking candidate bounding boxes (and selecting a final bounding box) is the extent to which the different boxes are consistent with a detected symmetry plane. Symmetry detection may, for example, be applied separately to each candidate box (e.g., each candidate box may be used to generate a crop of the 3D data to which symmetry detection is applied), or a single crop may be generated based on multiple candidate boxes for use in symmetry detection (e.g., utilizing the novel symmetry detection methodology described herein, an approximate crop mainly restricted to points/structure from a single object is generally sufficient, and a single approximate object crop may therefore be sufficient). Embodiments herein refer to processing techniques to transform an initial bounding box to a final bounding box based on a known or expected geometric relationship to a detected symmetry plane. It will be appreciated the geometric principles used to transform boxed in a symmetry-informed manner can equally be equally applied as a means of scoring or otherwise assessing different candidate boxes for consistency with an expected symmetry characteristic.

Example applications of the above perception techniques will now be described. It will be appreciated that the described applications are purely illustrative. The described applications are not exhaustive and it will be apparent that there are many other useful applications of the above techniques.

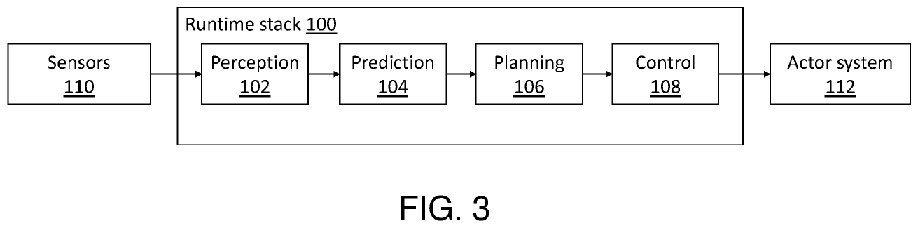

FIG. 3 shows a highly schematic block diagram of an AV runtime stack 100. The run time stack 100 is shown to comprise a perception (sub-)system 102, a prediction (sub-)system 104, a planning (sub-)system (planner) 106 and a control (sub-)system (controller) 108. As noted, the term (sub-)stack may also be used to describe the aforementioned components 102-108.

The perception techniques described above can be implemented within the perception system 102.

In a real-world context, the perception system 102 receives sensor outputs from an on-board sensor system 110 of the AV, and uses those sensor outputs to detect external agents and measure their physical state, such as their position, velocity, acceleration etc. The on-board sensor system 110 can take different forms but generally comprises a variety of sensors such as image capture devices (cameras/optical sensors), lidar and/or radar unit(s), satellite-positioning sensor(s) (GPS etc.), motion/inertial sensor(s) (accelerometers, gyroscopes etc.) etc. The onboard sensor system 110 thus provides rich sensor data from which it is possible to extract detailed information about the surrounding environment, and the state of the AV and any external actors (vehicles, pedestrians, cyclists etc.) within that environment. The sensor outputs typically comprise sensor data of multiple sensor modalities such as stereo images from one or more stereo optical sensors, lidar, radar etc. Sensor data of multiple sensor modalities may be combined using filters, fusion components etc.

The perception system 102 typically comprises multiple perception components which co-operate to interpret the sensor outputs and thereby provide perception outputs to the prediction system 104.

In a simulation context, depending on the nature of the testing—and depending, in particular, on where the stack 100 is “sliced” for the purpose of testing (see below)—it may or may not be necessary to model the on-board sensor system 100. With higher-level slicing, simulated sensor data is not required therefore complex sensor modelling is not required.

The perception outputs from the perception system 102 are used by the prediction system 104 to predict future behaviour of external actors (agents), such as other vehicles in the vicinity of the AV.

Predictions computed by the prediction system 104 are provided to the planner 106, which uses the predictions to make autonomous driving decisions to be executed by the AV in a given driving scenario. The inputs received by the planner 106 would typically indicate a drivable area and would also capture predicted movements of any external agents (obstacles, from the AV's perspective) within the drivable area. The driveable area can be determined using perception outputs from the perception system 102 in combination with map information, such as an HD (high definition) map.

A core function of the planner 106 is the planning of trajectories for the AV (ego trajectories), taking into account predicted agent motion. This may be referred to as trajectory planning. A trajectory is planned in order to carry out a desired goal within a scenario. The goal could for example be to enter a roundabout and leave it at a desired exit; to overtake a vehicle in front; or to stay in a current lane at a target speed (lane following). The goal may, for example, be determined by an autonomous route planner (not shown).

The controller 108 executes the decisions taken by the planner 106 by providing suitable control signals to an on-board actor system 112 of the AV. In particular, the planner 106 plans trajectories for the AV and the controller 108 generates control signals to implement the planned trajectories. Typically, the planner 106 will plan into the future, such that a planned trajectory may only be partially implemented at the control level before a new trajectory is planned by the planner 106. The actor system 112 includes “primary” vehicle systems, such as braking, acceleration and steering systems, as well as secondary systems (e.g. signalling, wipers, headlights etc.).

The example of FIG. 3 considers a relatively “modular” architecture, with separable perception, prediction, planning and control systems 102-108. The sub-stack themselves may also be modular, e.g. with separable planning modules within the planning system 106. For example, the planning system 106 may comprise multiple trajectory planning modules that can be applied in different physical contexts (e.g. simple lane driving vs. complex junctions or roundabouts). This is relevant to simulation testing for the reasons noted above, as it allows components (such as the planning system 106 or individual planning modules thereof) to be tested individually or in different combinations. For the avoidance of doubt, with modular stack architectures, the term stack can refer not only to the full stack but to any individual sub-system or module thereof.

The extent to which the various stack functions are integrated or separable can vary significantly between different stack implementations—in some stacks, certain aspects may be so tightly coupled as to be indistinguishable. For example, in other stacks, planning and control may be integrated (e.g. such stacks could plan in terms of control signals directly), whereas other stacks (such as that depicted in FIG. 3) may be architected in a way that draws a clear distinction between the two (e.g. with planning in terms of trajectories, and with separate control optimizations to determine how best to execute a planned trajectory at the control signal level). Similarly, in some stacks, prediction and planning may be more tightly coupled. At the extreme, in so-called “end-to-end” driving, perception, prediction, planning and control may be essentially inseparable. Unless otherwise indicated, the perception, prediction, planning and control terminology used herein does not imply any particular coupling or modularity of those aspects.

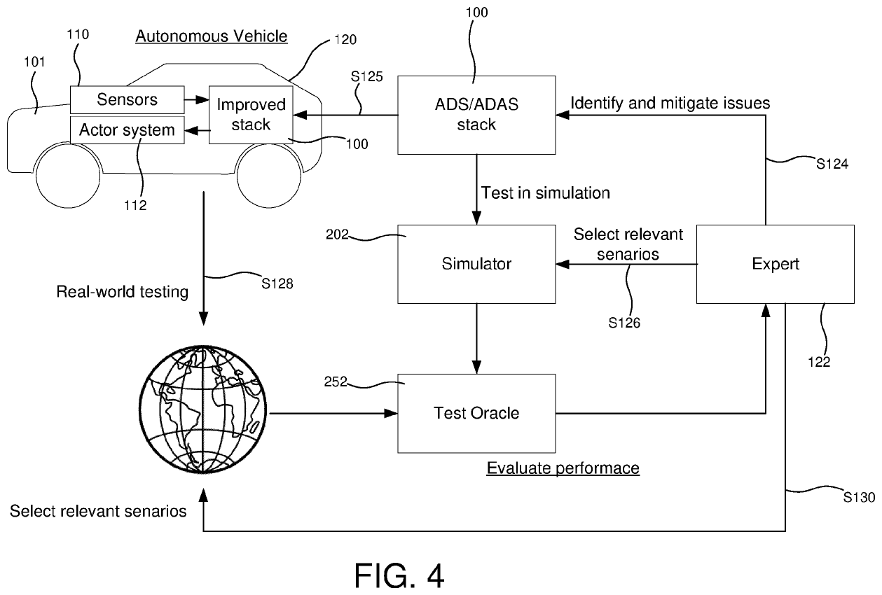

FIG. 4 shows a highly schematic overview of a testing paradigm for autonomous vehicles. An ADS/ADAS stack 100, e.g. of the kind depicted in FIG. 3, is subject to repeated testing and evaluation in simulation, by running multiple scenario instances in a simulator 202, and evaluating the performance of the stack 100 (and/or individual subs-stacks thereof) in a test oracle 252. The output of the test oracle 252 is informative to an expert 122 (team or individual), allowing them to identify issues in the stack 100 and modify the stack 100 to mitigate those issues (S124). The results also assist the expert 122 in selecting further scenarios for testing (S126), and the process continues, repeatedly modifying, testing and evaluating the performance of the stack 100 in simulation. The improved stack 100 is eventually incorporated (S125) in a real-world AV 101, equipped with a sensor system 110 and an actor system 112. The improved stack 100 typically includes program instructions (software) executed in one or more computer processors of an on-board computer system of the vehicle 101 (not shown). The software of the improved stack is uploaded to the AV 101 at step S125. Step 125 may also involve modifications to the underlying vehicle hardware.

On board the AV 101, the improved stack 100 receives sensor data from the sensor system 110 and outputs control signals to the actor system 112. Real-world testing (S128) can be used in combination with simulation-based testing. For example, having reached an acceptable level of performance though the process of simulation testing and stack refinement, appropriate real-world scenarios may be selected (S130), and the performance of the AV 101 in those real scenarios may be captured and similarly evaluated in the test oracle 252.

Scenarios can be obtained for the purpose of simulation in various ways, including manual encoding. The system is also capable of extracting scenarios for the purpose of simulation from real-world runs, allowing real-world situations and variations thereof to be re-created in the simulator 202.

The above perception techniques can be applied to synthetic sensor data, for example in a simulation-based testing context, or used to generate training data that is used to build a statistical model(s) of the perception system 102, such as perception error models, used for the purpose of testing. Such perception error models may be referred to as Perception Statistical Performance Models (PSPMs) or, synonymously, “PRISMs”. Further details of the principles of PSPMs, and suitable techniques for building and training them, may be bound in International Patent Publication Nos. WO2021037763 WO2021037760, WO2021037765, WO2021037761, and WO2021037766, each of which is incorporated herein by reference in its entirety.

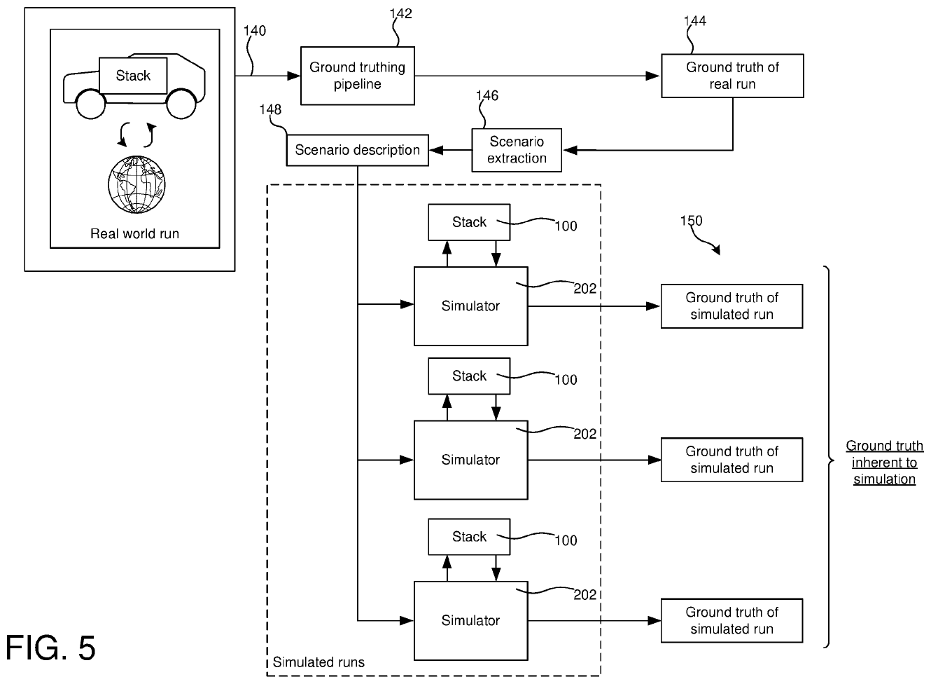

FIG. 5 shows a highly schematic block diagram of a scenario extraction pipeline. Data 140 of a real-world run is passed to a ‘ground-truthing’ pipeline 142 for the purpose of generating scenario ground truth. The run data 140 could comprise, for example, sensor data and/or perception outputs captured/generated on board one or more vehicles (which could be autonomous, human-driven or a combination thereof), and/or data captured from other sources such external sensors (CCTV etc.). The run data is processed within the ground truthing pipeline 142, in order to generate appropriate ground truth 144 (trace(s) and contextual data) for the real-world run. As discussed, the ground-truthing process could be based on manual annotation of the ‘raw’ run data 142, or the process could be entirely automated (e.g. using offline perception method(s)), or a combination of manual and automated ground truthing could be used. For example, 3D bounding boxes may be placed around vehicles and/or other agents captured in the run data 140, in order to determine spatial and motion states of their traces. A scenario extraction component 146 receives the scenario ground truth 144, and processes the scenario ground truth 144 to extract a more abstracted scenario description 148 that can be used for the purpose of simulation. The scenario description 148 is consumed by the simulator 202, allowing multiple simulated runs to be performed. The simulated runs are variations of the original real-world run, with the degree of possible variation determined by the extent of abstraction. Ground truth 150 is provided for each simulated run.

Scenario extraction is another useful application of the perception techniques of the present disclosure. For example, the aforementioned perception techniques can be deployed within the ground truthing pipeline 142 to facilitate high quality scenario extraction.

It will be appreciated that terminology such as CNNs, convolutional layers etc refers to functional components of a computer system that carry out a particular task(s) or function(s). References herein to components, functions, modules and the like, denote functional components of a computer system which may be implemented at the hardware level in various ways. A computer system comprises execution hardware which may be configured to execute the method/algorithmic steps disclosed herein and/or to implement a model trained using the present techniques. The term execution hardware encompasses any form/combination of hardware configured to execute the relevant method/algorithmic steps. The execution hardware may take the form of one or more processors, which may be programmable or non-programmable, or a combination of programmable and non-programmable hardware may be used. Examples of suitable programmable processors include general purpose processors based on an instruction set architecture, such as CPUs, GPUs/accelerator processors etc. Such general-purpose processors typically execute computer readable instructions held in memory coupled to or internal to the processor and carry out the relevant steps in accordance with those instructions. Other forms of programmable processors include field programmable gate arrays (FPGAs) having a circuit configuration programmable though circuit description code. Examples of non-programmable processors include application specific integrated circuits (ASICs). Code, instructions etc. may be stored as appropriate on transitory or non-transitory media (examples of the latter including solid state, magnetic and optical storage device(s) and the like).

A first aspect of the present disclosure provides a computer-implemented method of estimating a 3D object pose, the method comprising: receiving 3D data comprising a full or partial view of a 3D object, the 3D object exhibiting reflective symmetry about an unknown 2D symmetry plane; applying symmetry detection to the 3D data, and thereby calculating, in 3D space, an estimated 2D symmetry plane for the 3D object; and applying 3D pose detection to the 3D data based on the estimated 2D symmetry plane, thereby computing a 3D pose estimate of the 3D object that is informed by the reflective symmetry of the 3D object.

An initial 3D pose estimate may be computed, wherein a refined 3D pose estimate is computed based on the initial 3D pose estimate and the estimated 2D symmetry plane. The refined 3D pose estimate may be computed based on a subset of the 3D data, wherein the subset of the 3D data is extracted based on the initial 3D pose estimate. The extraction of the subset of the 3D data may be further based on an estimated extent of the 3D object.

The initial 3D pose estimate and the estimated extent may be provided in the form of a detected 3D bounding object for the 3D object.

The 3D bounding object may be determined in the form of a 3D bounding box by applying a 3D bounding box detector to the 3D data.

The refined 3D pose estimate may be computed by transforming the initial 3D pose estimate may be based on at least one assumption about a location and/or orientation of the 3D object relative to the estimated 2D symmetry plane.

The 3D bounding object may be transformed such that the transformed 3D bounding object has a predetermined geometric relationship to the estimated 2D symmetry plane. The 3D bounding object may be transformed such that the estimated 2D symmetry plane lies along a predefined axis of the transformed 3D bounding object.

A set of proposed 3D bounding objects may be generated for the 3D object, and computing the 3D pose estimate may comprise using the estimated 2D symmetry plane to select a 3D bounding box of the proposed set of bounding boxes.

The 3D bounding box may be selected based on at least one assumption about a location and/or orientation of the 3D object relative to the estimated 2D symmetry plane.

Applying symmetry detection to the 3D data may comprise generating an output tensor, by processing a voxel array in a convolutional neural network, the voxel array encoding a full or partial view of the 3D object, wherein each element of the output tensor corresponds to a portion of a 3D volume containing the 3D object, and contains a predicted offset of that portion from the unknown 2D symmetry plane.

The method may further comprise: dividing a voxel representation of the 3D data into horizontal slices; extracting for each horizontal slice a first feature tensor, by processing the horizontal slice in a 2D convolutional neural network (CNN) based on 2D convolutions within the 2D CNN, each 2D convolution performed by sliding a filter across a horizontal plane in only two dimensions, the first feature tensor comprising one or more first feature maps encoding local features of any portion of the 3D object occupying that horizontal slice; generating a second feature tensor for each horizontal slice, by providing the first feature tensors as a sequenced input to a convolutional recurrent neural network (CRNN), with the first feature tensors ordered to match a vertical order of the horizontal slices; wherein applying symmetry detection comprises processing the second feature tensor of each horizontal slice in a decoder, in order to compute multiple predicted offsets for multiple portions of the slice, the predicted offset for each portion of the slice being a predicted offset between that portion of the slice and the unknown 2D symmetry plane.

Each horizontal slice may be encoded as a voxel array that encodes any portion of the 3D object occupying the horizontal slice.

The voxel array may have a height greater than one voxel.

An estimated location and orientation of the unknown 2D symmetry plane may be computed by computing and aggregating predicted offsets across all of the horizontal slices.

The plane may be computed as a set of plane parameters, wherein the estimated location and orientation of the unknown 2D symmetry plane is computed using a least-squares method to solve for the plane parameters.

Each first feature tensor of the sequenced input is concatenated with a global feature tensor extracted from the 3D volume for processing in the CRNN.

The pose detection may operate over six degrees of freedom in 3D space, defining a location and orientation of the object in 3D space.

The 3D object may be assumed to be a vehicle exhibiting a single unknown 2D symmetry plane running along the length of the vehicle.

The method may be implemented in a real-time perception system, or alternatively the method may be implemented in an offline ground truthing pipeline to generate 3D object ground truth for the 3D data.

A second aspect described herein provides a computer-implemented method of extracting features from 3D structure within a 3D volume of space, the method comprising: receiving a voxel representation of the 3D structure within the 3D volume, the voxel representation divided into horizontal slices; and processing each slice in a 2D convolutional neural network (CNN), in order to extract a first feature tensor, based on 2D convolutions within the 2D CNN, each 2D convolution performed by sliding a filter across a horizontal plane in only two dimensions, the first feature tensor comprising one or more first feature maps encoding local features of any portion of the 3D structure occupying that slice.

A further aspect described herein provides a computer-implemented method of detecting 3D object symmetry, the method comprising: receiving 3D data comprising a full or partial view of a 3D object within a 3D volume, the 3D object exhibiting reflective symmetry about an unknown 2D symmetry plane; voxelizing the 3D volume to encode the view of the 3D object in a voxel array; and processing the voxel array in a convolution neural network, in order to generate an output tensor, each element the output tensor corresponding to a portion of the 3D volume, and containing a predicted offset of that portion from the unknown 2D symmetry plane.

Further aspects described herein provide a computer system comprising one or more computers configured to implement the method of any method disclosed herein and a computer program comprising executable program instructions for programming a computer system to implement the method of any method disclosed herein.

### REFERENCES

Reference is made above to the following, each of which is incorporated herein by reference in its entirety:
[1] A. Alahi, K. Goel, V. Ramanathan, A. Robicquet, L. Fei-Fei, and S. Savarese. Social LSTM: Human Trajectory Prediction in Crowded Spaces. In CVPR, pages 961-971, 2016.
[2] J. Bohg, M. Johnson-Roberson, B. Le'on, J. Felip, X. Gratal, N. Bergstr\ddot{ }om, D. Kragic, and A. Morales. Mind the gap—robotic grasping under incomplete observation. In ICRA, pages 686-693, 2011.
[3] Holger Caesar, Varun Bankiti, Alex H. Lang, Sourabh Vora, Venice Erin Liong, Qiang Xu, Anush Krishnan, Yu Pan, Giancarlo Baldan, and Oscar Beijbom. nuscenes: A multimodal dataset for autonomous driving. arXiv preprint arXiv: 1903.11027, 2019.
[4] Angel X. Chang, Thomas Funkhouser, Leonidas Guibas, Pat Hanrahan, Qixing Huang, Zimo Li, Silvio Savarese, Manolis Savva, Shuran Song, Hao Su, Jianxiong Xiao, Li Yi, and Fisher Yu. ShapeNet: An Information-Rich 3D Model Repository. Technical Report arXiv:1512.03012, Stanford University—Princeton University—Toyota Technological Institute at Chicago, 2015.
[5] Chia-Tche Chang, Bastien Gorissen, and Samuel Melchior. Fast oriented bounding box optimization on the rotation group so(3). ACM Trans. Graph., 30(5), October 2011.
[6] R. Q. Charles, H. Su, M. Kaichun, and L. J. Guibas. Point-Net: Deep Learning on Point Sets for 3D Classification and Segmentation. In CVPR, pages 77-85, 2017.
[7] L. Chen, G. Papandreou, I. Kokkinos, K. Murphy, and A. L. Yuille. DeepLab: Semantic Image Segmentation with Deep Convolutional Nets, Atrous Convolution, and Fully Connected CRFs. TPAMI, 40(4):834-848, 2018.
[8] X. Chen, H. Ma, J. Wan, B. Li, and T. Xia. Multi-view 3D Object Detection Network for Autonomous Driving. In CVPR, pages 6526-6534, 2017.
[9] Kyunghyun Cho, Bart van Merri\ddot{ }enboer, Caglar Gulcehre, Dzmitry Bahdanau, Fethi Bougares, Holger Schwenk, and Yoshua Bengio. Learning Phrase Representations using RNN Encoder-Decoder for Statistical Machine Translation. In EMNLP, pages 1724-1734, 2014.
[10] Christopher B Choy, Danfei Xu, Jun Young Gwak, Kevin Chen, and Silvio Savarese. 3D-R2N2: A Unified Approach for Single and Multi-view 3D Object Reconstruction. In ECCV, 2016.
[11] Junyoung Chung, Caglar Gulcehre, Kyunghyun Cho, and Yoshua Bengio. Empirical evaluation of gated recurrent neural networks on sequence modeling. In NeurIPS Workshop on Deep Learning, 2014.
[12] Marcelo Cicconet, Vighnesh Birodkar, Mads Lund, Michael Werman, and Davi Geiger. A convolutional approach to reflection symmetry. PRL, 95:44-50, 2017.
[13] M. Cicconet, D. G. C. Hildebrand, and H. Elliott. Finding Mirror Symmetry via Registration and Optimal Symmetric Pairwise Assignment of Curves: Algorithm and Results. In ICCV-W, pages 1759-1763, 2017.
[14] Aleksandrs Ecins, Cornelia Ferm\ddot{ }uller, and Yiannis Aloimonos. Detecting Reflectional Symmetries in 3D Data Through Symmetrical Fitting. In ICCV-W, pages 1779-1783, 2017.
[15] Aleksandrs Ecins, Cornelia Ferm\ddot{ }uller, and Yiannis Aloimonos. Seeing Behind The Scene: Using Symmetry to Reason About Objects in Cluttered Environments. In IROS, pages 7193-7200, 2018.
[16] M. Elawady, C. Ducottet, O. Alata, C. Barat, and P. Colantoni. Wavelet-Based Reflection Symmetry Detection via Textural and Color Histograms. In ICCV-W, pages 1725-1733, 2017.
[17] M. Engelcke, D. Rao, D. Z. Wang, C. H. Tong, and I. Posner. Vote3 Deep: Fast object detection in 3D point clouds using efficient convolutional neural networks. In ICRA, pages 1355-1361, 2017.
[18] Christopher Funk*, Seungkyu Lee*, Martin R Oswald*, Stavros Tsogkas*, Wei Shen, Andrea Cohen, Sven Dickinson, and Yanxi Liu. 2017 ICCV Challenge: Detecting Symmetry in the Wild. In ICCV-W, pages 1692-1701, 2017.
[19] C. Funk and Y. Liu. Beyond Planar Symmetry: Modeling Human Perception of Reflection and Rotation Symmetries in the Wild. In ICCV, pages 793-803, 2017.
[20] Lin Gao, Ling-Xiao Zhang, Hsien-Yu Meng, Yi-Hui Ren, Yu-Kun Lai, and Leif Kobbelt. PRS-Net: Planar Reflective Symmetry Detection Net for 3D Models. TVCG, 2020.
[21] Yuan Gao and Alan L Yuille. Exploiting Symmetry and/or Manhattan Properties for 3D Object Structure Estimation from Single and Multiple Images. In CVPR, pages 7408-7417, 2017.
[22] R. I. Hartley and A. Zisserman. Multiple View Geometry in Computer Vision. Cambridge University Press, ISBN: 0521540518, second edition, 2004.
[23] Sepp Hochreiter and J\ddot{ }urgen Schmidhuber. Long Short-Term Memory. Neural Computation, 9(8): 1735-1780, 1997.
[24] Jarmo Ilonen, Jeannette Bohg, and Ville Kyrki. Threedimensional object reconstruction of symmetric objects by fusing visual and tactile sensing. IJRR, 33(2):321-341, 2014.
[25] K. Kang, H. Li, T. Xiao, W. Ouyang, J. Yan, X. Liu, and X. Wang. Object Detection in Videos with Tubelet Proposal Networks. In CVPR, pages 889-897, 2017.
   [26] Michael Kazhdan, Bernard Chazelle, David Dobkin, Adam Finkelstein, and Thomas Funkhouser. A Reflective Symmetry Descriptor. In ECCV, pages 642-656, 2002.
[27] Simon Korman, Roee Litman, Shai Avidan, and Alex Bronstein. Probably Approximately Symmetric: Fast Rigid Symmetry Detection With Global Guarantees. CGF, 34(1):2-13, February 2015.
[28] J. Ku, M. Mozifian, J. Lee, A. Harakeh, and S. L. Waslander. Joint 3D Proposal Generation and Object Detection from View Aggregation. In IROS, pages 1-8, 2018.
[29] A. Makhal, F. Thomas, and A. P. Gracia. Grasping Unknown Objects in Clutter by Superquadric Representation. In IRC, pages 292-299, 2018.
[30] Aur'elien Martinet, Cyril Soler, Nicolas Holzschuch, and Franc,ois X. Sillion. Accurate Detection of Symmetries in 3D Shapes. TOG, 25(2):439-464, 2006.
[31] N. J. Mitra, L. Guibas, and M. Pauly. Partial and Approximate Symmetry Detection for 3D Geometry. TOG, 25(3):560-568, 2006.
[32] Joshua Podolak, Philip Shilane, Aleksey Golovinskiy, Szymon Rusinkiewicz, and Thomas Funkhouser. A Planar-Reflective Symmetry Transform for 3D Shapes. TOG, 25(3):549-559, 2006.
[33] Nikhila Ravi, Jeremy Reizenstein, David Novotny, Taylor Gordon, Wan-Yen Lo, Justin Johnson, and Georgia Gkioxari. Accelerating 3d deep learning with pytorch3d. arXiv:2007.08501, 2020.
[34] A. Sadeghian, V. Kosaraju, A. Sadeghian, N. Hirose, H. Rezatofighi, and S. Savarese. Sophie: An Attentive GAN for Predicting Paths Compliant to Social and Physical Constraints. In CVPR, pages 1349-1358, 2019.
[35] S. Shi, X. Wang, and H. Li. Pointrenn: 3d object proposal generation and detection from point cloud. In CVPR, pages 770-779, 2019.
[36] Yifei Shi, Junwen Huang, Hongjia Zhang, Xin Xu, Szymon Rusinkiewicz, and Kai Xu. Symmetry Net: Learning to Predict Reflectional and Rotational Symmetries of 3D Shapes from Single-View RGB-D Images. TOG, 39(6), 2020.
[37] M. Siam, S. Valipour, M. Jagersand, and N. Ray. Convolutional gated recurrent networks for video segmentation. In ICIP, pages 3090-3094, 2017.
[38] Minhyuk Sung, Vladimir G Kim, Roland Angst, and Leonidas Guibas. Data-Driven Structural Priors for Shape Completion. TOG, 34(6):1-11, 2015.
[39] Sebastian Thrun and Ben Wegbreit. Shape From Symmetry. In ICCV, pages 1824-1831, 2005.
[40] W. Van Gansbeke, B. De Brabandere, D. Neven, M. Proesmans, and L. Van Gool. End-to-end Lane Detection through Differentiable Least-Squares Fitting. In ICCV-W, pages 905-913, 2019.
[41] Rama K. Vasudevan, Ondrej Dyck, Maxim Ziatdinov, Stephen Jesse, Nouamane Laanait, and Sergei V. Kalinin. Deep Convolutional Neural Networks for Symmetry Detection. Microscopy and Microanalysis, 24(S1): 112-113, 2018.
[42] B. Wu, A. Wan, X. Yue, and K. Keutzer. SqueezeSeg: Convolutional Neural Nets with Recurrent CRF for Real-Time Road-Object Segmentation from 3D LiDAR Point Cloud. In ICRA, pages 1887-1893, 2018.
[43] B. Wu, X. Zhou, S. Zhao, X. Yue, and K. Keutzer. Squeeze—SegV2: Improved Model Structure and Unsupervised Domain Adaptation for Road-Object Segmentation from a LiDAR Point Cloud. In ICRA, pages 4376-4382, 2019.
[44] Yuxin Wu and Kaiming He. Group Normalization. In ECCV, pages 3-19, 2018. 4 19
[45] Yan Yan, Yuxing Mao, and Bo Li. SECOND: Sparsely Embedded Convolutional Detection. Sensors, 18(10), 2018.
[46] Bin Yang, Ming Liang, and Raquel Urtasun. HDNET: Exploiting HD Maps for 3D Object Detection. In PMLR, volume 87, pages 146-155, 2018.
[47] B. Yang, W. Luo, and R. Urtasun. PIXOR: Real-time 3D Object Detection from Point Clouds. In CVPR, pages 7652-7660, 2018.
[48] Z. Yang, Y. Sun, S. Liu, and J. Jia. 3DSSD: Point-Based 3D Single Stage Object Detector. In CVPR, pages 11037-11045, 2020. 2
[49] Tianwei Yin, Xingyi Zhou, and Philipp Kr\ddot{ }ahenb\ddot{ }uhl. Centerbased 3d object detection and tracking. CVPR, 2021. 6, 7, 8
[50] S. Zheng, S. Jayasumana, B. Romera-Paredes, V. Vineet, Z. Su, D. Du, C. Huang, and P. H. S. Torr. Conditional Random Fields as Recurrent Neural Networks. In ICCV, pages 1529-1537, 2015. 1
[51] Yin Zhou and Oncel Tuzel. VoxelNet: End-to-End Learning for Point Cloud Based 3D Object Detection. In CVPR, pages 4490-4499, 2018. 2
[52] Thomas Zielke, Michael Brauckmann, and Werner von Seelen. Intensity and edge-based symmetry detection applied to carfollowing. In ECCV, pages 865-873, 1992. 1

1. A computer-implemented method of estimating a 3D object pose, the method comprising:
receiving 3D data comprising a full or partial view of a 3D object, the 3D object exhibiting reflective symmetry about an unknown 2D symmetry plane;
applying symmetry detection to the 3D data, and thereby calculating, in 3D space, an estimated 2D symmetry plane for the 3D object; and
applying 3D pose detection to the 3D data based on the estimated 2D symmetry plane, thereby computing a 3D pose estimate of the 3D object that is informed by the reflective symmetry of the 3D object.

2. The method of claim 1, wherein an initial 3D pose estimate is computed, and wherein a refined 3D pose estimate is computed based on the initial 3D pose estimate and the estimated 2D symmetry plane.

3. The method of claim 2, wherein the refined 3D pose estimate is computed based on a subset of the 3D data, wherein the subset of the 3D data is extracted based on the initial 3D pose estimate and an estimated extent of the 3D object.

4. (canceled)

5. The method of claim 3, wherein the initial 3D pose estimate and the estimated extent are provided in the form of a detected 3D bounding object for the 3D object.

6. The method of claim 5, wherein the 3D bounding object is determined in the form of a 3D bounding box by applying a 3D bounding box detector to the 3D data.

7. The method of claim 2, wherein the refined 3D pose estimate is computed by transforming the initial 3D pose estimate based on at least one assumption about a location and/or orientation of the 3D object relative to the estimated 2D symmetry plane.

8. The method of claim 5, wherein the refined 3D pose estimate is computed by transforming the 3D bounding object such that the estimated 2D symmetry plane lies along a predefined axis of the transformed 3D bounding object.

9. (canceled)

10. The method of claim 1, wherein a set of proposed 3D bounding objects is generated for the 3D object, and computing the 3D pose estimate comprises using the estimated 2D symmetry plane to select a 3D bounding box of the proposed set of bounding boxes.

11. The method of claim 10, wherein the 3D bounding box is selected based on at least one assumption about a location and/or orientation of the 3D object relative to the estimated 2D symmetry plane.

12. The method of claim 1, wherein applying symmetry detection to the 3D data comprises generating an output tensor, by processing a voxel array in a convolutional neural network, the voxel array encoding a full or partial view of the 3D object, wherein each element of the output tensor corresponds to a portion of a 3D volume containing the 3D object, and contains a predicted offset of that portion from the unknown 2D symmetry plane.

13. The method of claim 1, comprising:
dividing a voxel representation of the 3D data into horizontal slices;
extracting for each horizontal slice a first feature tensor, by processing the horizontal slice in a 2D convolutional neural network (CNN) based on 2D convolutions within the 2D CNN, each 2D convolution performed by sliding a filter across a horizontal plane in only two dimensions, the first feature tensor comprising one or more first feature maps encoding local features of any portion of the 3D object occupying that horizontal slice;
generating a second feature tensor for each horizontal slice, by providing the first feature tensors as a sequenced input to a convolutional recurrent neural network (CRNN), with the first feature tensors ordered to match a vertical order of the horizontal slices; wherein applying symmetry detection comprises processing the second feature tensor of each horizontal slice in a decoder, in order to compute multiple predicted offsets for multiple portions of the slice, the predicted offset for each portion of the slice being a predicted offset between that portion of the slice and the unknown 2D symmetry plane.

14. The method of claim 13, wherein each horizontal slice is encoded as a voxel array that encodes any portion of the 3D object occupying the horizontal slice.

15. (canceled)

16. The method of claim 14, wherein an estimated location and orientation of the unknown 2D symmetry plane is computed by computing and aggregating predicted offsets across all of the horizontal slices.

17. The method of claim 16, wherein the plane is computed as a set of plane parameters, and the estimated location and orientation of the unknown 2D symmetry plane is computed using a least-squares method to solve for the plane parameters.

18. The method of claim 13, wherein each first feature tensor of the sequenced input is concatenated with a global feature tensor extracted from the 3D volume for processing in the CRNN.

19. (canceled)

20. The method of claim 1, wherein the 3D object is assumed to be a vehicle exhibiting a single unknown 2D symmetry plane running along the length of the vehicle.

21. The method of claim 1, implemented in a real-time perception system.

22. The method of claim 1, implemented in an offline ground truthing pipeline to generate 3D object ground truth for the 3D data.

23. A computer system comprising one or more processors and memory holding computer-readable instructions configured, when executed by the one or more processors, to implement a method of extracting features from 3D structure within a 3D volume of space, the method comprising:
receiving a voxel representation of the 3D structure within the 3D volume, the voxel representation divided into horizontal slices; and
processing each slice in a 2D convolutional neural network (CNN), in order to extract a first feature tensor, based on 2D convolutions within the 2D CNN, each 2D convolution performed by sliding a filter across a horizontal plane in only two dimensions, the first feature tensor comprising one or more first feature maps encoding local features of any portion of the 3D structure occupying that slice.

24.-25. (canceled)

26. A non-transitory computer-readable storage medium holding executable program instructions for programming a computer system to implement the steps of:
receiving 3D data comprising a full or partial view of a 3D object within a 3D volume, the 3D object exhibiting reflective symmetry about an unknown 2D symmetry plane;
voxelizing the 3D volume to encode the view of the 3D object in a voxel array; and
processing the voxel array in a convolution neural network, in order to generate an output tensor, each element the output tensor corresponding to a portion of the 3D volume, and containing a predicted offset of that portion from the unknown 2D symmetry plane.
